(19) United States
(12) Patent Application Publication
(10) Pub. No.: US 2005/0233082 A1
(43) Pub. Date: Oct. 20, 2005

(54) Method for conveying substrate, coating apparatus, and optical film

(76) Inventor: Tomonari Ogawa, Fujinomiya-shi (JP)

Correspondence Address: YOUNG & THOMPSON, 745 SOUTH 23RD STREET, 2ND FLOOR, ARLINGTON, VA, 22202, US

(21) Appl. No.: 11/090,849

(22) Filed: Mar. 25, 2005

(30) Foreign Application Priority Data
Mar. 26, 2004 (JP) 2004-093656

(51) Int. Cl. B05D 3/02; B05D 3/00; C04B 41/00; B05C 1/00

(52) U.S. Cl. 427/314; 427/532; 118/211; 118/244

(57) ABSTRACT

According to the present invention, a region in the vicinity of a width edge of a running substrate is locally heated, so that it is possible to eliminate irregular coating portions which may be caused by elongation and wrinkles at the edges of the web and also possible to provide the heating device at a low cost.

### BACKGROUND OF THE INVENTION

1. Field of the Invention

The present invention relates to a method for conveying a substrate, a coating apparatus, and an optical film, and in particular to a method for conveying a substrate and a coating apparatus suitable for reducing imperfection of a coating on an optical film such as an optical compensation film, an antireflection film, an antiglare film and the like or a photographic film (a silver film), and to an optical film produced by using thereof.

2. Related Art

A representative example of producing a photographic film or an optical film involves applying a coating material on a surface of a strip-shaped substrate having flexibility (referred to as “a web”, hereinafter) using various coating apparatuses, and drying this coating material to form a coating film having various compositions. A web comprising a thermoplastic resin used for the purpose as described above is wound up in a roll to store it as a raw broad web. Immediately before applying the coating material, the web is unrolled from this wound roll, and then the coating material is applied onto the unrolled web under the condition that the web continues to be fed out from the roll.

In order to facilitate the movement of this raw web having a broad width, an embossing finish such as knurling is generally provided in the vicinity of each width edge of the web (so-called “deckle edge”) so as to achieve certain effects such as snit-slip properties.

However, during a period of time in which such a web is wound into a roll and stored, the deckle edges having embossing finishes in the vicinity of both edges are elongated and deformed, so that problems are easily produced which may be responsible for coating irregularities at a time of coating.

That is, when a web with both width edges in the form of deckle edges is wound in a roll, a diameter of an end portion of the wound roll body becomes larger than that of its middle portion. This roll is then stored as it is. A difference between these diameters causes plastic deformation in its end portions and results in elongation, which further increases the difference in diameters between the end portion and the middle portion and then may form wrinkles.

Thus, it is necessary to eliminate and discard the irregular coating portions in the vicinity of both edges of the half-finished product after the application of the coating material, and the plastic deformation at the edges of the web may cause the decrease in process yield.

In the case of successive coating in which another coating material is further applied onto an already formed coating film on a web surface, a film thickness in the vicinity of a width edge of the coating film may be increased, so that problems may easily be produced which may cause coating irregularities at a time of coating.

In order to address these problems, it has been proposed that a web before coating is heat-treated at a predetermined temperature so as to be recovered from its plastic deformation condition to its normal condition for improving planarity of the web (especially, for improvement of deflection along an overall width such as core set or curling) (Japanese Patent Application Laid-open No. 8-304956).

### SUMMARY OF THE INVENTION

However, it cannot say that such a method for improving the planarity is substantially effective under the present condition. That is, when an overall width of a web before coating is heat-treated as described in Japanese Patent Application Laid-open No. 8-304956, the heat treatment is effected not only in an embossed portion in the vicinity of each edge whose planarity is required to be improved but also in a middle portion of the width.

In such a case, big problems will not produced as long as the temperature regulation is properly carried out, but when a heating temperature is higher, the middle portion of the web width becomes crinkled or undesirably elongates, which may cause irregular coating. Further, in the case of heating the overall width of the web, the cost for introducing facilities and for running thereof increases excessively, which may also increase the production cost.

The present invention is achieved in view of these circumstances. And an object of the present invention is, in the field of photographic film or an optical film which requires to be coated with a thin film with high precision, to provide a stable coating condition which does not produce an irregular coating by employing a method for conveying a web, even when a web raw web is used which has an embossing finish in the vicinity of each width edge of the web.

In order to achieve the above described object, the present invention provides a method for conveying a substrate and an apparatus therefor, wherein a region in the vicinity of a width edge of a running substrate is locally heated by a local heating device before applying a coating material onto the running substrate having a strip-shape and flexibility by a coating device.

According to the present invention, a region in the vicinity of a width edge of a running substrate is locally heated, so that it is possible to eliminate irregular coating portions which may be caused by elongation and wrinkles at the edges of the web and also possible to provide the heating device at a low cost.

That is, only a region in the vicinity of the edge is locally heated as opposed to Japanese Patent Application Laid-open No. 8-304956 in which an overall width of the web before coating is heat-treated, so that the plastic deformation condition at the embossed portion can be recovered to a normal condition and the planarity at the middle portion in the width direction used for the products can be secured.

On the other hand, when the overall width of the web is heated, the heat treatment also effects in a region which does not need to be subjected to a planarizing process. Thus, it is known that the potential irregularity formed at a time of producing a web (wrinkle irregularity) will become obvious if the web is strongly heated. In addition, excessive contraction of the web may produce dimensional problems, and for example, an overall width of the web will decrease. On the contrary, the present invention in which only an edge is required to be heated does not produce the above described problems.

In the present invention, it is preferable that the substrate is a thermoplastic film, and that the local heating device is any of an infrared heater, a far-infrared heater, a lamp, an electrothermal heater, a heating roller, and a hot air generating device, and a combination thereof. Applying the local heating device such as the far-infrared heater to a web of the thermoplastic film, the plastic deformation condition of the web can efficiently be recovered to its normal condition.

Further, in the present invention, the substrate is preferably heated to a glass transition temperature Tg-35° C. of the substrate or more. And in the present invention, the substrate is preferably heated for 0.5 seconds or more. In the present invention, a tensile force of the substrate is preferably set at 300 N/m or less. By heating the web as described above, the plastic deformation condition of the web can efficiently be recovered to its normal condition.

Further, in the present invention, a region in the vicinity of a width edge of the substrate is preferably heated from a front surface and/or a back surface. And in the present invention, a portion to be heated of the substrate which is opposed to the local heating device preferably has a width of 100 mm or less from a width edge of the substrate. According to this constitution, the plastic deformation condition of the web can efficiently be recovered to its normal condition.

Further, in the present invention, the local heating device is preferably divided into several compartments along a running direction of the substrate. And in the present invention, the local heating device is preferably divided in several compartments along a width direction of the substrate. As long as the local heating device is divided into several compartments as described above, the temperature regulation of the local heating device can be meticulously carried out. Therefore the present invention becomes more effective.

The present invention can also adopt an overall width heating device for heating an overall width of the substrate, which is provided upstream and/or downstream of the local heating device along a running direction of the substrate. By adopting such a constitution, for example, the entire web can be heated by the overall width heating device before being treated by the local heating device, so that the processing time by the local heating device can be reduced. In addition, defects such as elongations or wrinkles found in the middle portion of the web width can be eliminated by the overall width heating device.

In the present invention, a coating device includes, but is not specifically limited to, a bar coater (referred to as “a rod coater” and including a Mayer bar coater), a gravure coater (a direct gravure coater, a gravure kiss coater or the like), a roll coater (a transfer roll coater, a reverse roll coater, or the like), a die coater, an extrusion coater, a fountain coater, a slide hopper or the like.

An optical film also includes a film having various functions, such as an optical compensation film, an antireflection film, an antiglare film or the like.

According to the present invention as described above, a region in the vicinity of a width edge of the substrate is locally heated, so that the irregular coating due to elongation or wrinkles at the edge of the web can be eliminated, and further, a heating device can be provided at a very low cost.

### BRIEF DESCRIPTION OF THE DRAWINGS

FIG. 1 is an explanation drawing for describing a production line of an optical film to which a method for conveying a substrate and a coating apparatus according to the present invention are applied;

FIG. 2 is a substantial perspective view showing an example of a local heating device;

FIG. 3 is a sectional view for describing a constitution of a gravure coating apparatus;

FIG. 4 is a substantial perspective view showing another example of the local heating device;

FIG. 5 is an explanation drawing for showing still another example of the local heating device and the like;

FIG. 6 is a table showing the results of Example 1; and

FIG. 7 is a table showing the results of Example 2.

### DETAILED DESCRIPTION OF THE PREFERRED EMBODIMENTS

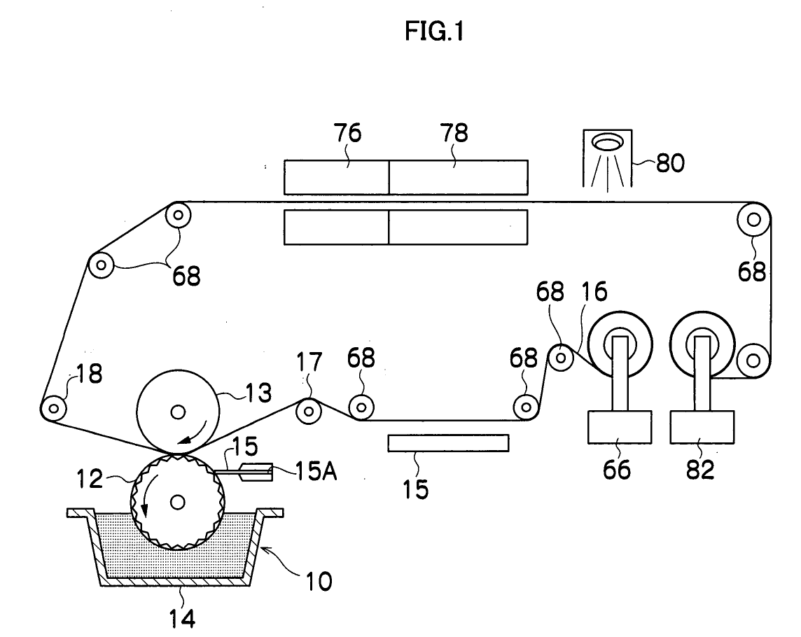

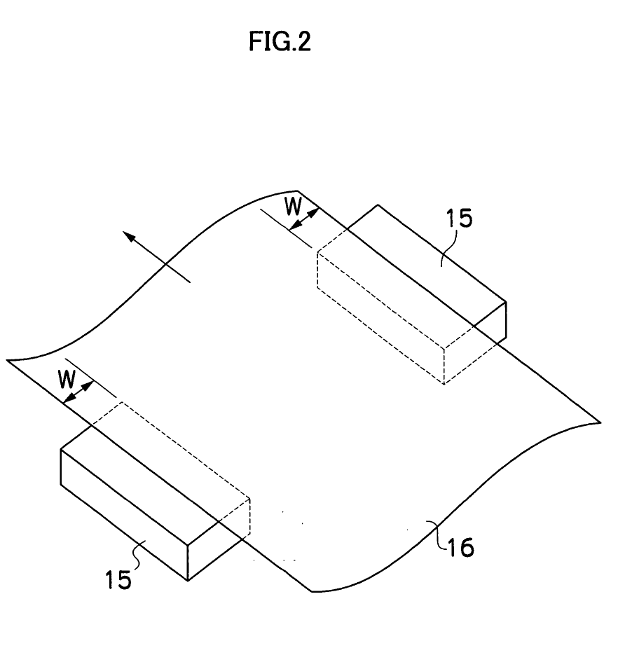

A preferred embodiment (a first embodiment) of a method for conveying a substrate, a coating apparatus, and an optical film according to the present invention will now be described in detail with reference to appended drawings. FIG. 1 is an explanation drawing for describing a production line of an optical film to which a method for conveying a substrate and an apparatus according to the present invention is applied. FIG. 2 is a substantial perspective view showing an example of a local heating device in the production line.

In a production line of an optical film as shown in FIG. 1, a web 16 made of a transparent substrate and a polymer layer which is pre-formed thereon is fed from a feeder 66. The web 16 is guided by a guide roller 68 and fed to a zone in which an edge heater 15 is provided as a local heating device. A temperature of the edge heater 15 can be adjusted such that the plastic deformation condition at the embossed portion in the vicinity of each width edge of the web 16 can be recovered to its normal condition.

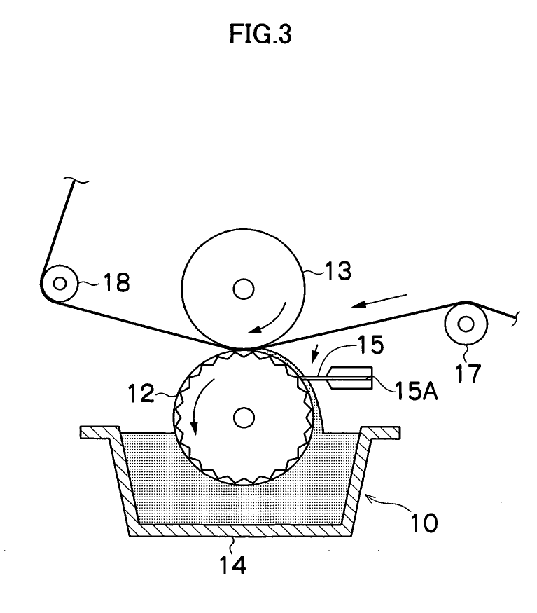

A gravure coating apparatus 10 is provided downstream of the zone in which the edge heater 15 is provided, where a coating material can be applied onto the web 16. Details on the gravure coating apparatus 10 will be described later with reference to FIG. 3.

A drying zone 76 and a heating zone 78 are successively provided downstream of the gravure coating apparatus 10, where a liquid crystal layer can be formed on the web 16. Further, an ultraviolet lamp 80 is provided downstream of these zones, where the liquid crystals are cross-linked by the ultraviolet irradiation for obtaining a desired polymer. Then, a take-up apparatus 82 provided downstream of this zone rolls up the web 16 on which a polymer is formed.

As shown in FIG. 2, edge heaters (local heating devices) 15 are positioned under the regions in the vicinity of both edges along a width direction of the web 16 such that the heaters come close to the web 16. In addition to the edge heater 15, the local heating device includes a visible light lamp, a heating roller, a burner, a hot air generating device, or a combination thereof.

A various type of heaters, such as an infrared heater, a far-infrared heater, an electrothermal heater or the like, can be adopted as the edge heater 15. In the present embodiment, a far-infrared heater is adopted as the edge heater 15. As a far-infrared heater, a ceramics heater (Type PLC) or a ceramics plate heater (Type PLR) manufactured by Noritake Co., Ltd. can be used for example.

A surface temperature (maximum working temperature), a capacity (unit: W) or the like of the edge heater may be optimally selected depending on a material quality or a thickness of the web 16, a running speed of the web 16, a pre-heating (for example, presence or absence of an overall width heating device for heating an overall width of the web 16) or the like.

In FIG. 2, a width W of each portion to be heated of the web 16 opposing to each of the edge heaters 15 exists in a width of 100 mm from the width edge of the web 16. The width W having such a value allows for effective local heating of the web 16. This width W is more preferably 30 to 50 mm.

A position of the edge heater 15 along the width direction of the web 16 is as shown in FIG. 2, however, if a portion to be heated of the web 16 is not the embossed portion but a deckle edge for thicker coating, which is thicker than the embossed portion, the edge heater 15 is preferably positioned along the width direction of the web 16 to face this deckle edge for thicker coating.

As a method for regulating a temperature of the edge heater 15, various regulation methods well known in the art can be used such as on/off control, P (proportional) control, PI (proportional & integral) control, PID (proportional, integral & differential) control, and control by a microcomputer.

Next, a gravure coating apparatus 10 will be described. As shown in FIG. 3, the gravure coating apparatus 10 is an apparatus in which a web 16 running by the guidance of an upstream guide roller 17 and a downstream guide roller 18 is sandwiched between a gravure roller 12 driven rotationally and a backup roller 13 for applying thereto a coating material to a predetermined thickness.

Each of the gravure roller 12, the backup roller 13, the upstream guide roller 17, and the downstream guide roller 18 has a length generally identical to a width of the web 16. The gravure roller 12 is rotationally driven in a counterclockwise direction as indicated by an arrow in FIG. 3. This rotative direction corresponds to a running direction of the web 16. The rollers can be reversely rotated (in a clockwise direction) for coating unlike with FIG. 2, depending on the coating conditions.

Although the gravure roller 12 is driven directly by an inverter motor (directly coupled to the motor), it is possible to use a combination of any one of various motors and a reducer (a gear head) or a wrapping connector such as a timing belt plus any one of various motors.

The backup roller 13 is dragged in a clockwise direction as the gravure roller 12 is driven. The backup roller 13 may be provided with a driving device.

A cell shape on a surface of the gravure roller 12 may be any of well-known shapes like a pyramid, grid, or oblique line. That is, the cell shape can be selected as appropriate depending on a coating speed, a viscosity of a coating material, a thickness of a coating layer or the like.

A pan for reserving liquid 14 is provided under the gravure roller 12, where a coating material is filled therein. A lower half portion of the gravure roller 12 is dipped in the coating material. According to this constitution, the coating material is supplied to a cell on a surface of the gravure roller 12.

In order to scrape the excessive coating material off the roll before coating, a doctor blade 15 is located at 2 o'clock position of the gravure coater 12 such that a tip portion of the doctor blade 15 comes into contact with the gravure coater 12. The doctor blade 15 having its pivoting center at a base end portion thereof is biased in a direction indicated by an arrow by using a biasing device (not shown).

The upstream guide roller 17 and the downstream guide roller 18 are supported in parallel with the gravure roller 12. Preferably, the upstream guide roller 17 and the downstream guide roller 18 whose end portions are rotatably supported by bearing members (ball bearing or the like) are not provided with driving mechanisms.

Since the gravure apparatus 10 as described above is especially effective for applying a thin layer, this apparatus 10 is preferably applied to an optical film production line in which a thin layer containing a 10 ml/m² or less of wet coating material is applied (whose film thickness at a time of coating is 10 μm or less) for example.

In the present embodiment, the gravure apparatus 10 may be installed in a clean atmosphere such as in a clean room. Preferably, the degree of cleanliness class is 1000 or less, and preferably 100 or less, and more preferably 10 or less.

In the present invention, the number of coating layers to be applied by using coating solutions are not limited, but multiple layers can be simultaneously applied as necessary.

The coating apparatus includes, in addition to the above described gravure apparatus 10, a bar coater, a roll coater (a transfer roll coater, a reverse roll coater, or the like), a die coater, an extrusion coater, a fountain coater, a curtain coater, a dip coater, a spin coater, a spray coater, a slide hopper or the like.

Next, an optical film produced by using the method for conveying the substrate and the coating apparatus according to the present invention will be described.

As the web 16 used for the present invention, it is preferable to use a polymer film whose optical transmittance is 80% ore more. It is preferable to use a polymer in which birefringence will not easily occur when external force is applied thereto. Examples of such polymer are cellulosic polymers, norbornene polymers (for example, ARTON (produced by JSR Corp.), ZEONOR, ZEONEX (both are produced by ZEON Corp.)), and polymethyl methacrylate. The cellulosic polymers are preferably used, and more preferably cellulosic esters, and even more preferably lower fatty acid esters of cellulose.

The lower fatty acid means fatty acid having 6 or less carbon atoms. The number of carbon atoms is preferably 2 (cellulose acetate), 3 (cellulose propionate), or 4 (cellulose butyrate). Cellulose acetate is preferable as the cellulose ester, and includes diacetyl sellulose and triacetyl cellulose for example. It is also possible to use mixed fatty acid esters such as cellulose acetate propionate or cellulose acetate butyrate.

Generally, hydroxyl groups at 2-, 3-, and 6-positions of cellulose acetate are not equally distributed thereto respectively, and a degree of substitution at each position is not ⅓ of the total. In the present invention, a degree of substitution at the 6-position of cellulose acetate is preferably higher than that at the 2- or 3-position thereof.

The hydroxyl group at the 6-position is preferably substituted by an acyl group at a degree of 30% to 40% relative to whole degree of substitution and more preferably 31% or more, and even more preferably 32% or more. Further, a degree of substitution of the acyl group at a 6-position of cellulose acetate is preferably 0.88 or more.

In addition to an acetyl group, a hydroxyl group at a 6-position may also be substituted by an acyl group having 3 or more carbon atoms, such as propionyl group, a butyroyl group, a valeroyl group, a benzoyl group, or a acryloyl group. Measurement of the degree of substitution at each position can be carried out by NMR.

As cellulose acetate used for the present invention, it is possible to use cellulose acetate obtained by synthetic methods of Synthesis Example 1 described in paragraphs 0043 to 0044 and Synthesis Example 2 described in paragraphs 0048 to 0049, and Synthesis Example 3 described in paragraphs 0051 to 0052 of Japanese Patent Application Laid-open No. 11-5851.

In order to adjust the retardation of the polymer film, an aromatic compound having at least two aromatic rings is used as a retardation enhancing agent.

When a cellulose acetate film is used as the polymer film, the aromatic compound is used within a range of 0.01 to 20 parts by mass based on 100 parts by mass of the cellulose acetate. The aromatic compound is preferably used within a range of 0.05 to 15 parts by mass based on 100 parts by mass of the cellulose acetate, and more preferably within a range of 0.1 to 10 parts by mass. It is also possible to used two or more aromatic compounds simultaneously. The aromatic ring of the aromatic compound includes an aromatic heterocyclic ring in addition to an aromatic hydrocarbon ring.

In particular, the aromatic hydrocarbon ring is preferably a 6-membered ring (that is, a benzene ring). The aromatic heterocyclic ring is generally an unsaturated heterocyclic ring. The aromatic heterocyclic ring is preferably a 5-membered ring, a 6-membered ring, or a 7-membered ring, and more preferably a 5-membered ring or a 6-membered ring. The aromatic heterocyclic ring generally has the maximal possible double bonds. Among preferable hetero atoms are a nitrogen atom, an oxygen atom, and a sulfur atom, and more preferably a nitrogen atom.

Examples of the aromatic heterocyclic ring are a furan ring, a thiophene ring, a pyrrole ring, an oxazole ring, an isoxazole ring, a thiazole ring, an isothiazole ring, an imidazole ring, a pyrrazole ring, a furazane ring, a triazole ring, a pyran ring, a pyridine ring, a pyridazine ring, a pyrimidine ring, a pyrazine ring, and a 1,3,5-triazine ring. Preferable aromatic rings are a benzene ring, a furan ring, a thiophene ring, a pyrrole ring, an oxazole ring, a thiazole ring, an imidazole ring, a triazole ring, a pyridine ring, a pyrimidine ring, a pyrazine ring, and a 1,3,5-triazine ring, and more preferably a benzene ring and a 1,3,5-triazine ring. In particular, the aromatic compound preferably has at least one 1,3,5-triazine ring.

The number of the aromatic ring contained in the aromatic compound is preferably 2 to 20, and more preferably 2 to 12, and even more preferably 2 to 8, and most preferably 2 to 6. The bonding form between two aromatic rings is classified into three cases: (a) a fused ring is formed; (b) two aromatic rings are directly connected via a single bond; and (c) two aromatic rings are connected through a linking group (a spiro bonding is not formed because of the aromatic ring). Any bonding form selected from the cases (a) to (c) may be suitable.

Examples of the fused ring in (a) (a fused ring formed from two or more aromatic rings) are an indene ring, a naphthalene ring, an azulene ring, a fluorene ring, a phenanthrene ring, an anthracene ring, an acenaphtylene ring, a naphthacene ring, a pyrene ring, an indole ring, an isoindole ring, a benzofuran ring, a benzothiophene ring, an indolydine ring, a benzoxazole ring, a benzothiazole ring, a benzoimidazole ring, a benzotriazole ring, a purine ring, an indazole ring, a chromene ring, a quinoline ring, an isoquinoline ring, a quinolizine ring, a quinazoline ring, a cinnolin ring, a quinoxaline ring, a phthalazine ring, a pteridine ring, a carbazole ring, an acridine ring, a phenanthridine ring, a xanthene ring, a phenazine ring, a phenothiazine ring, a phenoxathiine ring, a phenoxazine ring, and a thianthrene ring, and preferably a naphthalene ring, an azulene ring, an indole ring a benzoxazole ring, a benzothiazole ring, a benzoimidazole ring, a benzotriazole ring, and a quinoline ring.

The single bond in (b) is preferably a bond between carbon atoms of two aromatic rings. The two aromatic rings may be connected via two or more single bonds to form an aliphatic ring or a nonaromatic heterocyclic ring between these two aromatic rings.

The linking group in (c) is also preferably connected to carbon atoms of two aromatic rings. The linking group is preferably an alkylene group, an alkenylene group, an alkynylene group, —CO—, —O—, —NH—, —S—, or a combination thereof. Examples of the linking group comprised of such a combination are as follows. The left-to-right relationship of each example may be reversed.
c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and the linking group may have substituents. Among such substituents are halogen atoms (F, Cl, Br, I), a hydroxyl group, a carboxyl group, a cyano group, an amino group, a nitro group, a sulfonyl group, a carbamoyl group, a sulfamoyl group, an ureide group, alkyl groups, alkenyl groups, alkynyl groups, aliphatic acyl groups, aliphatic acyloxy groups, alkoxy groups, alkoxycarbonyl groups, alkoxycarbonylamino groups, alkylthio groups, alkylsulfonyl groups, aliphatic amide groups, aliphatic sulfone amide groups, aliphatic substituted amino groups, aliphatic substituted carbamoyl groups, aliphatic substituted sulfamoyl groups, aliphatic substituted ureide groups, and nonaromatic heterocyclic groups.

The number of carbon atoms included in the alkyl group is preferably 1 to 8. Chain alkyl groups are more preferable than cyclic alkyl groups, and in particular, straight chain alkyl groups are more preferable. Further, the alkyl group may have substituents (for example, a hydroxyl group, a carboxyl group, an alkoxy group, or an alkyl substituted amino group). Examples of the alkyl group (including substituted alkyl groups) are methyl, ethyl, n-butyl, n-hexyl, 2-hydroxyethyl, 4-carboxybutyl, 2-methoxyethyl, and 2-diethylaminoethyl. The number of carbon atoms included in the alkenyl group is preferably 2 to 8. Chain alkenyl groups are more preferable than cyclic alkenyl groups, and in particular, straight chain alkenyl groups are more preferable. The alkenyl group may further have substituents.

Examples of the alkeynl group are vinyl, allyl, 1-hexenyl and the like. The number of carbon atoms included in the alkynyl group is preferably 2 to 8. Chain alkynyl groups are more preferable than cyclic alkynyl groups, and in particular, straight chain alkynyl groups are more preferable. The alkynyl group may further have substituents. Examples of the alkynyl group are ethynyl, 1-butynyl, 1-hexynyl and the like.

The number of carbon atoms included in the aliphatic acyl group is preferably 1 to 10. Among examples of the aliphatic acyl group are acetyl, propanoyl, and butanoyl. The number of carbon atoms included in the aliphatic acyloxy group is preferably 1 to 10. An example of the aliphatic acyloxy group is acetoxy or the like. The number of carbon atoms included in the alkoxy group is preferably 1 to 8. The alkoxy group may further have substituents (for example, an alkoxy group).

Among examples of the alkoxy group (including substituted alkoxy groups) are methoxy, ethoxy, butoxy, and methoxyethoxy. The number of carbon atoms included in the alkoxycarbonyl group is preferably 2 to 10. Examples of the alkoxycarbonyl group are methoxycarbonyl, ethoxycarbonyl and the like. The number of carbon atoms included in the alkoxycarbonylamino group is preferably 2 to 10. Examples of the alkoxycarbonylamino group are methoxycarbonylamino, ethoxycarbonylamino and the like.

The number of carbon atoms included in the alkylthio group is preferably 1 to 12. Among examples of the alkylthio group are methylthio, ethylthio, and octylthio.

The number of carbon atoms included in the alkylsulfonyl group is preferably 1 to 8. Among examples of the alkylsulfonyl group are methanesulfonyl and ethanesukfonyl.

The number of carbon atoms included in the aliphatic amide group is preferably 1 to 10. Among examples of the aliphatic amide group is acetamide. The number of carbon atoms included in the aliphatic sulfoneamide group is preferably 1 to 8. Among examples of the aliphatic sulfoneamide group are methanesulfoneamide, butanesulfoneamide, and n-octanesulfoneamide. The number of carbon atoms included in the aliphatic substituted amino group is preferably 1 to 10. Among examples of the aliphatic substituted amino group are dimethylamino, diethylamino, and 2-carboxyethylamino.

The number of carbon atoms included in the aliphatic substituted carbamoyl group is preferably 2 to 10. Among examples of the aliphatic substituted carbamoyl group are methylcarbamoyl and diethylcarbamoyl. The number of carbon atoms included in the aliphatic substituted sulfamoyl group is preferably 1 to 8. Among examples of the aliphatic substituted sulfamoyl group are methylsulfamoyl and diethylsulfamoyl. The number of carbon atoms included in the aliphatic substituted ureide group is preferably 2 to 10. Among examples of the aliphatic substituted ureide group is methylureide. Examples of the nonaromatic heterocyclic ring group are piperidino, morpholino and the like. Molecular weight of the retardation enhancing agent is preferably 300 to 800.

Examples of the retardation enhancing agent are described in Japanese Patent Application Laid-open Nos. 2000-111914, 2000-275434, and PCT/JP00/02619.

An embodiment will be described below which uses a cellulose acetate film as the polymer film. The cellulose acetate film is preferably produced by a solvent casting. In the solvent casting, cellulose acetate is dissolved in an organic solvent and the resultant solution (dope) is used for producing a film.

The organic solvent is preferably includes a solvent selected from ethers having 3 to 12 carbon atoms, ketones having 3 to 12 carbon atoms, esters having 3 to 12 carbon atoms, and halogenated hydrocarbons having 1 to 6 carbon atoms.

Ethers, ketones and esters may have cyclic structures. A compound having two or more functional groups from ethers, ketones and esters (that is, —O—, —CO—, and —COO—) can also be used as the organic solvent. The organic solvent may have other functional groups such as alcoholic hydroxyl groups. As for the organic solvent having two or more functional groups, the number of carbon atoms may be within a certain range as defined above for a compound having any functional group.

Among examples of ethers having 3 to 12 carbon atoms are diisopropyl ether, dimethoxymethane, dimethoxyethane, 1,4-dioxane, 1,3-dioxorane, tetrahydrofuran, anisole, and phenetole. Among examples of ketones having 3 to 12 carbon atoms are acetone, methylethylketone, diethylketone, diisobutylketone, cyclohexanone, and methylcyclohexanone. Among examples of esters having 3 to 12 carbon atoms are ethyl formate, propyl formate, pentyl formate, methyl acetate, ethyl acetate, and pentyl acetate.

Among examples of organic solvents having two or more functional groups are 2-ethoxyethyl acetate, 2-methoxy ethanol, and 2-butoxy ethanol. The number f carbon atoms included in the halogenated hydrocarbon is preferably 1 or 2, and most preferably 1. Halogen in the halogenated hydrocarbon is preferably chlorine. Percentage of hydrogen atoms, substituted by halogens, in the halogenated hydrocarbon is preferably 25 to 75 mol %, and more preferably 30 to 70 mol %, and even more preferably 35 to 65 mol %, and most preferably 40 to 60 mol %. Methylene chloride is a representative halogenated hydrocarbon.

Although the halogenated hydrocarbons such as methylene chloride can be used without problems technically, it is preferable that the organic solvent does not substantially contain halogenated hydrocarbons in view of global environment or work environment. The term “not substantially contain” means that a percentage of the halogenated hydrocarbon in the organic solvent is less than 5% by mass (preferably less than 2% by mass). In addition, it is preferable that the halogenated hydrocarbons such as methylene chloride is not detected at all in the produced cellulose acylate film. Two or more organic solvents may also be mixed before using thereof.

A cellulose acetate solution can be prepared by a general method. The general method means that a treatment is carried out at a temperature more than 0° C. (at ordinary temperature or at a high temperature). Preparation of the solution can be carried out by using a method for preparing a dope and an apparatus in the ordinary solvent casting. In the case of using a common method, halogenated hydrocarbon (especially, methylene chlodride) is preferably used as the organic solvent. An amount of cellulose acetate is adjusted so as to be included at 10 to 40% by mass in the resultant solution. The amount of the cellulose acetate is more preferably at 10 to 30% by mass.

Any additives described below may also be added to the organic solvent (a prime solvent). This solution can be prepared by stirring cellulose acetate in the organic solvent at ordinary temperature (0 to 40° C.). A solution of high concentration may be stirred under the pressurized and heated conditions. Specifically, cellulose acetate and the organic solvent are placed in a pressurized container and this container is hermetically sealed, and then the cellulose acetate and the organic solvent are stirred under the pressurized condition while heating them at a temperature range between a boiling point at ordinary temperature of the solvent and a temperature at which the solvent will not be boiled. The heating temperature is usually 40° C. or more, preferably 60 to 200° C., and more preferably 80 to 110° C.

Respective components may be roughly mixed with each other before placing them in the container. Alternatively, these components may also be successively introduced into the container. The container is required to be formed such that these components can be stirred therein. The container can be pressurized by injecting thereto an inert gas such as a nitrogen gas. An increase in a vapor pressure of the solvent due to heating thereof may also be used for pressurization. Alternatively, respective components may be added to the container under pressure after the container is hermetically sealed.

When heating is effected, the container is preferably heated from an outside thereof. For example, a jacket type of heating apparatus can be used. In addition, the container can be entirely heated by providing a plate heater outside this container and then circulating a liquid throughout the piping installed therebetween. Materials in the container are preferably stirred with agitating blades provided within the container. The agitating blade has preferably a length which reaches the vicinity of a wall of the container. A scraping blade is preferably provided at a terminal end of the agitating blade in order to renew a liquid film on the wall of the container. The container may be provided with instruments such as a pressure gauge and a thermometer. Respective components are dissolved in the solvent within the container. The prepared dope may be cooled before removing thereof from the container, or alternatively the prepared dope may be removed before cooling thereof with the use of a heat exchanger.

Preparation of a cellulose acetate solution (dope) according to the present invention is carried out by dissolution and cooling, which will now be described below. Cellulose acetate is, at first, gradually added to an organic solvent with stirring at around room temperature (−10 to 40° C.). When a plurality of solvents are used, the order in which these solvents are added thereto is not specifically limited.

For example, cellulose acetate may be added to a prime solvent before adding another solvent (for example, a solvent formed by gelatinizing alcohol) thereto, or vise versa. That is, cellulose acetate may be moistened with a gelatinized solvent, and to which a prime solvent may be added. This process is effective for preventing these components from dissolving un-uniformly. The amount of cellulose acetate is preferably adjusted so as to be included in this mixture at 10 to 40% by mass. The amount of cellulose acetate is more preferably at 10 to 30% by mass. Further, any additives described below may also be added to the mixture.

Next, the mixture is cooled to −100 to −10° C. (preferably −80 to −10° C., more preferably −50 to −20° C., and most preferably −50 to −30° C.). This mixture may be cooled in a dry ice-methanol bath (−75° C.) or in a cooled solution of diethylene glycol (−30 to −20° C.). The mixture of cellulose acetate and organic solvent thus cooled is solidified. The cooling rate is not specifically limited. However, when the mixture is cooled in batches, it is necessary to use a dissolver which can efficiently achieve a predetermined cooling temperature because the viscosity of cellulose acetate increases as the temperature decreases and thus the cooling efficiency is impaired.

The cellulose acetate solution according to the present invention can be achieved by transferring a cooling apparatus which is set at a predetermined cooling temperature for a short time after swelling the solution. The cooling rate is preferably at higher level, but a theoretical upper limit of the cooling rate is 10000° C./sec., and a technical upper limit of the cooling rate is 1000° C./sec., and a practical upper limit of the cooling rate is 100° C./sec.

The cooling rate is obtained by dividing a difference between a temperature at the beginning of cooling and a temperature at the completion cooling by a time period required to reach the final cooling temperature from the beginning of cooling. Once the mixture is warmed at 0 to 200° C. (preferably 0 to 150° C., more preferably 0 to 120° C., and most preferably 0 to 50° C.), it is possible to obtain a solution in which cellulose acetate flows within the organic solvent. Such warming can be achieved by simply allowing the mixture to stand at room temperature, or by placing the mixture in a hot bath.

A homogeneous solution can be obtained as described above. If the respective components are not sufficiently dissolved in the solvent, operations for cooling and warming can be repeated. It is also possible to determine whether these components are dissolved only by making visual observation of an appearance of the solution.

In the dissolution and cooling, it is desired to use a hermetically sealed container in order to prevent moisture from being introduced therein due to condensation at the time of cooling. Further, during the operations for cooling and warming, a time period required to dissolve the respective components can be reduced by applying a pressure at the time of cooling and by decreasing a pressure at the time of warming. In order to perform pressurization and depressurization, it is desirable to use a pressure tight container.

A 20% by mass solution of cellulose acetate (acetylation degree: 60.9%, viscosity-average polymerization degree: 299) in methyl acetate has a pseudo-phase transition point at around 33° C. which is between a sol state and a gel state as measured by the differential scanning calorimetry (DSC), and this solution becomes a gel state at this temperature or below.

Therefore, this solution have to be stored at a temperature above the pseudo-phase transition point, and preferably at a gel phase transition temperature ±10° C. The pseudo-phase transition temperature may vary depending on the acetylation degree and viscosity-average polymerization degree of cellulose acetate, the concentration of the solution, and the organic solvent to be used.

From the produced solution of cellulose acetate (dope), a cellulose acetate film is produced by the solvent casting. Again, the above described retardation enhancing agent is preferably added to the dope. The dope is cast on a surface of a drum or a band, from which the solvent is evaporated to form a film. The concentration of solids contained in the dope before casting is preferably adjusted at 10 to 40%, and more preferably at 18 to 35%. The surface of the drum or band is preferably given a mirror finish.

A process for casting and drying in the solvent casting is described in U.S. Pat. Nos. 2,336,310, 2,367,603, 2,492,078, 2,492,977, 2,492,978, 2,607,704, 2,739,069, 2,739,070, G.B. Patent Nos. 640731, 736892, Japanese Examined Application Publication Nos. 45-4554, 49-5614, Japanese Patent Application Laid-open Nos. 60-176834, 60-203430, 62-115035.

The dope is preferably cast on a surface of a drum or band whose surface temperature is 10° C. or less. The dope after being cast is preferably air-dried for 2 seconds. The resultant film may also be stripped off the drum or band, and then dried in the air at high temperatures varying from 100 to 160° C. for evaporating the remaining solvent. This method is described in Japanese Examined Application Publication No. 5-17844. This method allows for reducing a time period which is required from casting to stripping. For practicing this method, it is necessary to gelatinize the dope at a surface temperature of the drum or band at the time of casting.

In the present invention, the resultant solution of cellulose acetate as a monolayer may be cast on a smooth surface of a drum or band as the web 16, or alternatively two or more layers of cellulose acetate solution may be cast on the drum or band. When a plurality of cellulose acetate solutions are cast, the solutions containing cellulose acetate may be cast from a plurality of casting ports provided at intervals along a running direction of the web 16 to form a film comprising several solution components laminated with each other. For practicing this process, it is possible to use a method described in Japanese Patent Application Laid-open Nos. 61-158414, 1-122419, or 11-198285, for example.

Formation of the film is also achieved by casting a cellulose acetate solution from two casting ports, and can be achieved by a method described in Japanese Examined Application Publication No. 60-27562, Japanese Patent Application Publication Nos. 61-94724, 61-947245, 61-104813, 61-158413, or 6-134933. Further, as described in Japanese Patent Application Publication No. 56-162617, it is also possible to use a method for casting a cellulose acetate film, in which a stream of a high viscosity cellulose acetate solution is confined in a low viscosity cellulose acetate solution and then these cellulose acetate solutions respectively having high and low viscosities are simultaneously extruded.

Alternatively, the film may also be produced by using two casting ports, that is, a film formed on a web 16 using a first casting port is stripped off the web 16 and then another solution is cast on a web side surface of the stripped film. This method is described in Japanese Examined Application Publication No. 44-20235, for example. These cellulose acetate solutions to be cast are not specifically limited and may be the same as or different from each other. In order to provide a plurality of cellulose acetate layers with some functions, cellulose acylate solutions corresponding to such functions may be extruded from respective casting ports.

In addition, the cellulose acetate solution according to the present invention can be cast simultaneously with other functional layers (for example, an adhesive layer, a dye layer, an antistatic layer, an anti-halation layer, a UV absorption layer, and a polarized layer). In the case of conventional monolayer solution, it was necessary to extrude a cellulose acetate solution having a high concentration and a high viscosity for obtaining a desired film thickness, so that the stability of the cellulose acetate solution was not sufficient and solids were produced within the solution, and thus often resulting in some problems such as grainy and/or uneven coating. In order to solve these problems, a plurality of cellulose acetate solutions may be cast from the casting ports to extrude the high viscosity solutions onto the web 16 simultaneously, therefore it is possible not only to produce a sheet-like film having an improved and excellent planarity but also to achieve reduction in drying load by using a thick cellulose acetate solution and to increase a production speed of the film.

A plasticizer may be added to the cellulose acetate film to improve its mechanical properties or to increase a drying speed. Phosphate esters or carboxylate esters are used as the plasticizer. Among examples of the phosphate esters are triphenyl phosphate (TPP) and tricresyl phosphate (TCP). Representative carboxylate esters are phthalate ester and citrate ester.

Among examples of the phthalate esters are dimethyl phthalate (DMP), diethyl phthalate (DEP), dibutyl phthalate (DBP), dioctyl phthalate (DOP), diphenyl phthalate (DPP), and diethylhexyl phthalate (DEHP). Examples of the citrate esters are triethyl o-acetylcitrate (OACTE), tributyl o-acetylcitrate (OACTB) and the like.

Among examples of other carboxylate esters are butyl oleate, methyl acetyl ricinoleate, dibutyl sebacate, and various esters of trimellitate. Plasticizers of phthalate esters (DMP, DEP, DBP, DOP, DPP, DEHP) are preferably used. DEP and DPP are particularly preferable. An amount of the plasticizer to be added is preferably 1 to 25% by mass, more preferably 1 to 20% by mass, and most preferably 3 to 15% by mass based on an amount of cellulose ester.

An antidegradant (for example, an antioxidant, a peroxide decomposer, a radical inhibitor, an acid scavenger, and amine) may also be added to the cellulose acetate film. The antidegradant is described in Japanese Patent Application Publication Nos. 3-199201, 5-1907073, 5-194789, 5-271471, or 6-107854. An amount of the antidegradant to be added is preferably 0.01 to 1% by mass, and more preferably 0.01 to 0.2% by mass based on a solution (dope) to be prepared. When the amount to be added is less than 0.01% by mass, effects of the antidegradant can be scarcely recognized. When the amount to be added is more than 1% by mass, the antidegradant may be bled out (leached out) on the film surface. Examples of particularly preferable antidegradants are butylated hydroxytoluene (BHT), tribenzylamine (TBA) and the like.

Next, a drawing process of the polymer film will be described. Retardation of the produced cellulose acetate film (polymer film) can also be adjusted by the drawing process. The draw ratio is preferably 3 to 100%. A thickness of the polymer film is preferably 40 to 140 μm, and more preferably 70 to 120 m. The angular standard deviation of the phase retardation axis of an optical compensation film can be reduced by adjusting the conditions of drawing process.

Methods for drawing are not specifically limited, but an example thereof is a method for drawing which uses a tenter. When a film produced by the above described solvent casting is subjected to lateral drawing by using a tenter, the angular standard deviation of the phase retardation axis of the film can be reduced by controlling the state of the film after drawing. Specifically, the standard deviation of the phase retardation axis angle can be reduced as follows: a drawing process which regulates a retardation value is performed by using a tenter; and then the polymer film immediately after the drawing is kept as it is at around a glass transition temperature of the film.

If the film is kept at a temperature lower than the glass transition temperature, the standard deviation becomes larger. In another example, the standard deviation of the phase retardation axis may be reduced by widen a gap between rolls when longitudinal drawing is performed between the rolls.

Next, a surface treatment of the polymer film will be described. When the polymer film is used as a transparent protective film of a deflection plate, the polymer film is preferably subjected to the surface treatment. Such surface treatments include a corona discharge treatment, a glow discharge treatment, a flame treatment, an acid treatment, an alkali treatment, or an ultraviolet irradiation treatment. The acid treatment or alkali treatment, that is, saponification is preferably carried out for the polymer film.

Next, an orientation film will be described. The orientation film has a function which defines an orientation of a discotic liquid crystal molecule within an optical anisotropic layer. The orientation film can be provided by, for example, a rubbing treatment of organic compounds (preferably polymers), oblique evaporation of inorganic compounds, formation of a layer having micro-grooves, or by accumulation of organic compounds (for example, ω-tricosane acid, dioctadecylmethylamminium chloride, methyl stearate) utilizing the Langmuir-Blodgett method (a LB film). Also known is an orientation film which exhibits an orientation function by applying an electrical field, a magnetic field, or by irradiating light.

The orientation film is preferably formed by the rubbing treatment of the polymer. Polyvinyl alcohol is a preferable polymer. Denatured poly vinyl alcohol linking to a hydrophobic group is particularly preferable. The hydrophobic groups can orient the discotic liquid crystal molecules in a uniform direction by introducing the hydrophobic groups into polyvinyl alcohol, because the hydrophobic groups have affinities to the discotic liquid crystal molecules within the optical anisotropic layer.

The hydrophobic group is allowed to bind to a terminal end of a backbone or a side chain of polyvinyl alcohol. The hydrophobic group is preferably an aliphatic group having 6 or more carbon atoms (preferably an alkyl group or an alkenyl group), or an aromatic group. When the hydrophobic group is linked to a terminal end of a backbone of polyvinyl alcohol, it is preferable that a linking group is introduced between the hydrophobic group and the terminal end of the backbone. Among examples of the linking groups are —S—, —C(CN)R₁—, —NR₂—, —CS—, and a combination thereof. The above described R₁ and R₂ are hydrogen atoms or alkyl groups having 1 to 6 carbon atoms (preferably, alkyl groups having 1 to 6 carbon atoms), respectively.

When the hydrophobic group is introduced to a side chain of polyvinyl alcohol, a part of an acetyl group (—CO—CH₃) in a vinyl acetate building block of polyvinyl alcohol may be substituted by an acyl group (—CO—R₃) having 7 or more carbon atoms. R₃ is an aliphatic group having 6 or more carbon atoms or an aromatic group. It is possible to use a commercially available denatured polyvinyl alcohol (for example, MP103, MP203, and R1130, produced by Kuraray Co., Ltd.). A saponification degree of the (denatured) polyvinyl alcohol used for the orientation film is preferably 80% or more. A polymerization degree of the (denatured) polyvinyl alcohol is preferably 200 or more.

The rubbing treatment is carried out by rubbing a surface of the orientation film with paper or cloth in a constant direction several times. It is preferable to use a cloth in which fibers having uniform lengths and diameters are uniformly planted. The orientation of the discotic liquid crystal molecules within the optical anisotropic layer can be kept, even if the orientation film is removed after performing orientation of the discotic liquid crystal molecules within the optical anisotropic layer using the orientation film. That is, the orientation film is essential for producing an elliptic deflection plate which is used for orienting the discotic liquid molecules, however, this orientation film is not essential for the produced optical compensation film.

When the orientation film is provided between the transparent web 16 and the optical anisotropic layer, it is preferable that an under coat (an adhesive layer) is further provided between the transparent web 16 and the orientation film. And in order to stabilize the sheet state, citrate ester may also be added thereto as required.

Next, the optical anisotropic layer will be described. The optical anisotropic layer is formed from discotic liquid crystal molecules. The discotic liquid crystal molecule has generally a uniaxial property which is optically negative. As for the optical compensation film according to the present invention, the discotic liquid molecule is preferable that an angle between a surface of a disc and a surface of the transparent web 16 varies along a depth direction of the optical anisotropic layer as shown in FIG. 2 (that is, a hybrid orientation). An optical axis of the discotic liquid molecule exists in a direction normal to the disc surface.

The discotic liquid crystal has a birefringence property in which a refractive index in an optical axis direction is larger than that in a disc surface direction. The optical anisotrpic layer is preferably formed by orienting the discotic liquid molecules with the above described orientation film and then fixing the discotic liquid molecules at their oriented position. The discotic liquid molecules are preferably fixed by a polymerization reaction.

In this optical anisotrpic layer, a direction in which a retardation value becomes zero does not exist. In other words, the minimum retardation value of the optical anisotropic layer is above zero. Specifically, it is preferable that the optical anisotropic layer has a Re retardation value defined by the following equation (I) within a range of 10 to 100 nm, a Rth retardation value defined by the following equation (II) within a range of 40 to 250 nm, and an average tilt angle of the discotic liquid molecules within a range of 20 to 50°.
Re=(nx−ny)×d (I)
Rth={(n2+n3)/2−n1}×d (II)

In the equation (I), nx is a refractive index in a direction of a phase retardation axis in plane of the optical anisotropic layer, ny is a refractive index in a direction of a phase advance axis in plane of the optical anisotropic layer, and d is a thickness of the optical anisotropic layer. In the equation (II), n1 is a minimum value of refractive index principal values which is obtained by approximating the optical anisotropic layer by a refractive index ellipsoid, n2 and n3 are other refractive index principal values of the optical anisotropic layer, and d is a thickness of the optical anisotropic layer.

The discotic liquid crystal molecules have been described in various literatures (C. Destrade et al., Mol. Crysr. Liq. Cryst., vol. 71, page 111 (1981); Chemical Society of Japan ed., quarterly chemical journal (Kikan Kagaku Sosetsu), No. 22, Chemistry of Liquid Crystal (Ekisho no Kagaku), Chapter 5, Chapter 10, Sction 2 (1994); B. Kohne et al., Angew. Chem. Soc. Chem. Comm., page 1794 (1985); J. Zhang et al., J. Am. Chem. Soc., vol. 116, page 2655 (1994)). Polymerization of the discotic liquid crystal molecules has been described in Japanese Patent Application Publication No. 8-27284.

For fixing the discotic liquid crystal molecules by polymerization, it is necessary to bind a polymerizable group as a substituent to a disc-like core of the discotic liquid crystal molecule. However, if the polymerizable group is directly bound to the disc-like core, it becomes difficult to keep the orientation state during their polymerization. Thus, a linking group is introduced between the disc-like core and the polymerizable group. Therefore, the discotic liquid crystal molecule having the polymerizable group is preferably a compound represented by the following formula (III):
D(-L-Q)n (III)
wherein D is a disc-like core, L is a divalent linking group, Q is a polymerizable group, and n is an integer from 4 to 12.

Examples of the disc-like core are as follows. In the following examples, LQ (or QL) means a combination of the divalent linking group (L) and the polymerizable group (Q).

In the formula (III), the divalent linking group (L) is preferably a divalent linking group selected from a group consisting of alkylene groups, alkenylene groups, arylene groups, —CO—, —NH—, —O—, —S—, and combinations thereof. The divalent linking group (L) is more preferably a divalent linking group comprising a combination of at least two divalent groups selected from a group consisting of alkylene groups, arylene groups, —CO—, —NH—, —O—, and —S—. The divalent linking group (L) is most preferably a divalent linking group comprising a combination of at least two divalent groups selected from a group consisting of alkylene groups, arylene groups, —CO—, and —O—. The number of carbon atoms included in the alkylene group is preferably 1 to 12. The number of carbon atoms included in the alkenylene group is preferably 2 to 12. The number of carbon atoms included in the arylene group is preferably 6 to 10. Examples of the divalent linking group (L) are as follows. A left side of the formula is connected to the disc-like core (D) and a right side of the formula is connected to the polymerizable group (Q). AL means an alkylene group or an alkenylene group, and AR means an arylene group. The alkylene groups, alkenylene groups and arylene groups may also have substituents (for example, alkyl groups).
L1: -AL-CO—O-AL-
L2: -AL-CO—O-AL-O—
L3: -AL-CO—O-AL-O-AL-
L4: -AL-CO—O-AL-O—CO—
L5: —CO-AR-O-AL-
L6: —CO-AR-O-AL-O—
L7: —CO-AR-O-AL-O—CO—
L8: —CO—NH-AL-
L9: —NH-AL-O—
L10: —NH-AL-O—CO—
L11: —O-AL-
L12: —O-AL-O—
L13: —O-AL-O—CO—
L14: —O-AL-O—CO—NH-AL-
L15: —O-AL-S-AL-
L16: —O—CO-AR-O-AL-CO—
L17: —O—CO-AR-O-AL-O—CO—
L18: —O—CO-AR-O-AL-O-AL-O—CO—
L19: —O—CO-AR-O-AL-O-AL-O-AL-O—CO—
L20: —S-AL-
L21: —S-AL-O—
L22: —S-AL-O—CO—
L23: —S-AL-S—CO—
L24: —S-AR-AL-

The polymerizable group (Q) of the formula (III) is determined depending on a type of polymerization.

The polymerizable group (Q) is preferably an unsaturated polymerizable group (Q1 to Q7) or an epoxy group (Q8), and more preferably an unsaturated polymerizable group, and most preferably an ethylenic unsaturated polymerizable group (Q1 to Q6). In the formula (III), n is an integer from 4 to 12. The specific figure is determined depending on a type of the disc-like core (D). A plurality of combinations of L and Q may be the same or different from each other.

The optical anisotropic layer can be formed by coating a surface of an orientation film with a coating solution including the discotic liquid crystal molecules and optionally a polymerization initiator or any other components. A thickness of the optical anisotropic layer is preferably 0.5 to 100 μm, and more preferably 0.5 to 30 μm.

The discotic liquid crystal molecules thus oriented are fixed as they are, with their orientation being kept. The fixation is preferably carried out by a polymerization reaction. The polymerization reactions include a thermal polymerization reaction which uses a thermal polymerization initiator and a photo polymerization reaction which uses a photo polymerization initiator. The photo polymerization reaction is preferable. Among examples of the photo polymerization initiators are α-carbonyl compounds (described in U.S. Pat. Nos. 2,367,661 and 2,367,670 respectively), acyloin ethers (described in U.S. Pat. No. 2,448,828), α-hydrocarbon substituted aromatic acyloin compounds (described in U.S. Pat. No. 2,722,512), poly-nuclear quinoline compounds (described in U.S. Pat. Nos. 3,046,127 and 2,951,758 respectively), a combination of a triarylimidazole dimer and p-aminophenylketone (described in U.S. Pat. No. 3,549,367), acridine and phenazine compounds (described in Japanese Patent Application Publication No. 60-105667 and U.S. Pat. No. 4,239,850), and oxadiazole compounds (described in U.S. Pat. No. 4,212,970).

The amount of photo polymerization initiator used is preferably 0.01 to 20% by mass and more preferably 0.5 to 5% by mass based on the solid content of the coating solution. For polymerization of the discotic liquid crystal molecules, it is preferable to use ultraviolet rays during photo-irradiation. Irradiation energy is preferably 20 to 5000 mJ/cm², and more preferably 100 to 800 mJ/cm². The photo-irradiation may also be effected under the heating condition in order to facilitate the photo polymerization reaction. A protective layer may be provided on the optical anisotropic layer. In addition, citrate esters may also be added as required for the purpose of stabilizing the sheet.

Next, a production method of the optical film, which uses a production line of the optical film as shown in FIG. 1, will be described. First, a web 16 having a thickness of 40 to 300 μm onto which a polymer layer is pre-formed is fed from a feeder 66. The web 16 is guided by a guide roller 68 and fed to a zone in which an edge heater 15 is provided as a local heating device, which locally heats a region in the vicinity of each edge of the web 16. Since only a region in the vicinity of each edge of the web 16 is locally heated, a middle portion of the web width to be coated does not deform by heat and thus the plastic deformation at the edge can efficiently be recovered. Accordingly, irregular coating which may be caused by elongation or wrinkles at the edge of the web 16 can be eliminated, and it becomes possible to provide the local heating device at a very low cost.

A time period for heating by the edge heater 15 is not specifically limited, but principally depends on temperatures of the substrate. That is, the time period for heating becomes effective as long as a temperature is sufficient to re-orient the molecules of the substrate. In the case of using triacetyl cellulose (TAC), a temperature of 70° C. or more becomes effective. Therefore, it is desirable to select a size, a setting temperature or the like of the edge heater 15 following these conditions. Further, a vertical distance between the edge heater 15 and the web 16 is generally 10 to 100 mm when a normal type of far-infrared heater or infrared heater is used.

Then, a coating solution is applied on the web 16 by the use of a gravure coating apparatus 10. After the completion of coating, the coated web 16 is transferred through a drying zone 76 and a heating zone 78 to form a liquid crystal layer. The liquid crystal layer is further irradiated with an ultraviolet lamp 80 to cross-link the liquid crystals, and then a desired polymer is formed. The web 16 on which the polymer is formed is rolled up by a take-up apparatus 82.

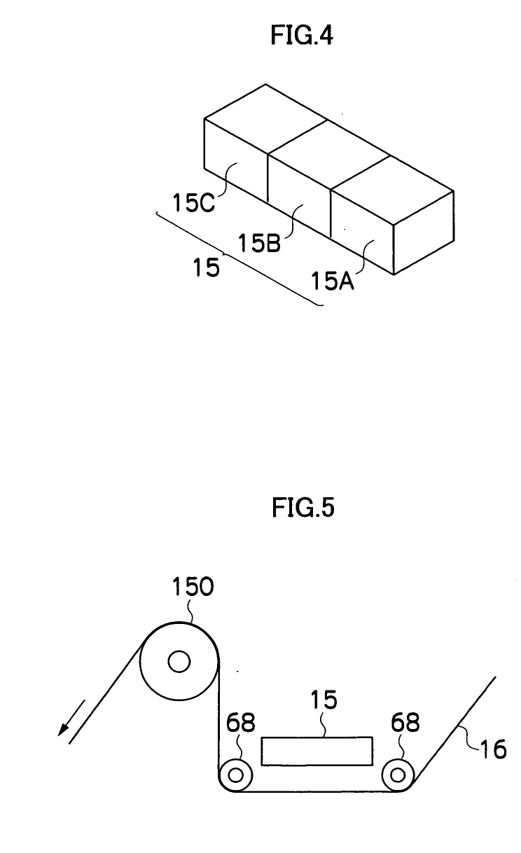

Next, a second embodiment of the method for conveying the substrate and the coating apparatus according to the present invention will be described. FIG. 4 is a perspective view showing an example of the edge heater 15. The edge heater 15 is divided into three blocks, and these three heater blocks 15A, 15B, and 15C are located in this order from an upstream of the running direction of the web 16. Thus, the temperature can be minutely controlled by dividing the edge heater 15 into several heater blocks and then controlling a temperature of each heater block. That is, heating times, heating temperature profiles or the like can easily be changed as appropriate by arranging a plurality of heater blocks.

Next, a third embodiment of the method for conveying the substrate and the coating apparatus according to the present invention will be described. FIG. 5 is an explanation drawing about a zone constitution within the production line of the optical film as shown in FIG. 1, in which the edge heater 15 as a local heating device is provided. Contrary to the first embodiment in FIG. 1, the edge heater 15 is provided above the web 16. In addition, an overall width heating roller 150 for heating a substantially full width of the web 16 is provided downstream of the edge heater 15.

Even when the edge heater 15 is located above the web 16, the region in the vicinity of each edge of the web 16 can be heated without any problems as in the case of the first embodiment. It is also possible to adopt a constitution in which two edge heaters 15 are provided above/below the web 16 respectively.

Adoption of the overall width heating roller 150 for heating a substantially full width of the web 16 allows for reduction in a processing time of the edge heater 15, for example by heating the web entirely with the overall width heating roller 150 as an overall width device after the treatment with the local heating device. Even when a middle portion of the web width has some defects such as elongation or wrinkles, the overall width heating roller 150 can eliminate such defects.

Although some embodiments of the method for conveying a substrate, the coating apparatus, and the optical film according to the present invention have been described, the present invention does not intend to be limited to the above described embodiments and can adopt various aspects.

For example, although the present embodiment uses a far-infrared heater as the edge heater 15 for the local heating device, various heating devices other than the far-infrared heater can be used, such as any one of an infrared heater, a visible light lamp, an electrothermal heater, a heating roller, a burner, and a hot air generating device, and a combination thereof.

Further, although the present embodiment performs consecutively local heating by the edge heater 15 and coating by the gravure coating apparatus 10, these heating and coating may also be performed separately. For example, the same effect can be produced even when the web 16 locally heated by the edge heater 15 is rolled up and then the web 16 is unwound from the roll after several days later.

Further, although the present embodiment is directed to an optical film as an intended purpose of the method for conveying a substrate and the coating apparatus, these method and apparatus may also be applied to various films (substrates) other than the optical film.

As a substitute for an aspect in which the edge heater 15 is divided in a running direction of the web 16 as in the second embodiment of the present invention, the edge heater 15 may also be divided in a width direction of the web 16. For example, a boundary portion between the deckle edge and the ordinary part (used for a product) often creates wrinkles depending on circumstances due to elongation of the web 16 and variation of contraction. In such a case, a temperature profile is provided along a width direction for taking measures against the wrinkles.

In addition, each width edge of the web 16 may be heated at a higher temperature while the inner portion of the web width may be heated at a lower temperature, depending on the embossed state of the web 16. This process is effective for efficiently recover the plastic deformation at the edges of the web 16.

In addition, various coating devices other than the gravure coating apparatus 10 can be used as a coating device, as described above.

### EXAMPLE 1

Using a production line of an optical film shown in FIG. 1, an optical film (an antiglare film) was produced under the various conditions. A wire bar coater was used in place of a gravure coating apparatus 10. A running speed of a web 16 was set at 10 m/min.

Triacetyl cellulose having a thickness of 80 μm (Fujitack, produced by Fuji Photo Film Co., Ltd.) was used as the web 16. The web 16, having a length of 3000 m and being rolled up, was unwound from the rolled up body as shown in FIG. 1.

A coating solution was prepared as follows. 75 g of a mixture of dipentaerythritolpentaacrylate and dipentaerythritolhexaacrylate (DPHA, produced by Nippon Kayaku Co., Ltd.) and 240 g of a hard coating solution containing a dispersion of zirconium oxide ultra fine particle having a particle size of 30 nm (DeSolite Z-7401, produced by JSR Corp.) were dissolved in 104 g of a mixed solution of methylethylketone/cyclohexanone=54/46% by weight.

10 g of a photo polymerization initiator (Irgacure 907, produced by Ciba Fine Chemicals Co., Ltd.) was added to the resultant solution, and after dissolving this initiator with stirring, 0.93 g of a fluorochemical surfactant comprising a 20% by weight solution of fluoro-oligomer in methylethylketone (Megaface F-176 PF, produced by Dainippon Ink and Chemicals Inc.) was added thereto (a refractive index of a coating film obtained by applying this solution and performing ultraviolet cure was 1.65).

To this solution, 29 g of a dispersion obtained by dispersing 20 g of cross-linked polystyrene particles having a number average particle size of 2.0 μm and a refractive index of 1.61 (SX-200HS, produced by Soken Chemical & Engineering Co., Ltd.) in 160 g of a mixed solvent of methylethylketone/cyclohexanone=54/46% by weight with the use of a high speed dispersing apparatus under the condition of 5000 rpm for one hour and then by filtering the resultant dispersion through polypropylene filters whose pore sizes were 10 μm, 3 μm, and 1 μm (PPE-10, PPE-03, and PPE-01 all produced by Fuji Photo Film Co., Ltd.) was added and stirred, and then the resultant dispersion was filtered through a polypropylene filter having a pore size of 30 μm to prepare a coating solution for an antiglare layer. A viscosity of the coating solution was 0.008 Ns/m², and a surface tension was 0.030 N/m.

A far-infrared heater (produced by Noritake Co.) was used as an edge heater 15, and this heater was set such that an edge portion of the heater (an inedge) could be located within a range between at a 100 mm distance from an edge of the web 16 toward an inside of the web 16 and at a 50 mm distance from the edge of the web 16 toward an outside of the web 16 (−50 mm) and that the edge portion of the heater could be located at different five points between the above described regions. That is, a width W shown in FIG. 2 was allowed to change from −50 mm to 100 mm.

A far-infrared ceramics heater was used as the edge heater 15. A dimension of the ceramics heater was 60×120 mm and its power was 300 W. Six ceramics heaters were located in a width direction to make its dimension 60×120 mm, and placed at a 50 mm distance below the web 16.

A surface temperature of the edge heater 15 (a preset temperature) was set at two levels such as 400° C. (Nos. 2, 3, 5, 6, and 7) and 500° C. (No. 4), and for comparison, an edge heater 15 was not used under the condition of No. 1. A surface temperature in the vicinity of the edge (embossed part) of the web 16 was determined by actually measuring thereof with an emission pyrometer at a position immediately after passing the web 16 through the edge heater 15.

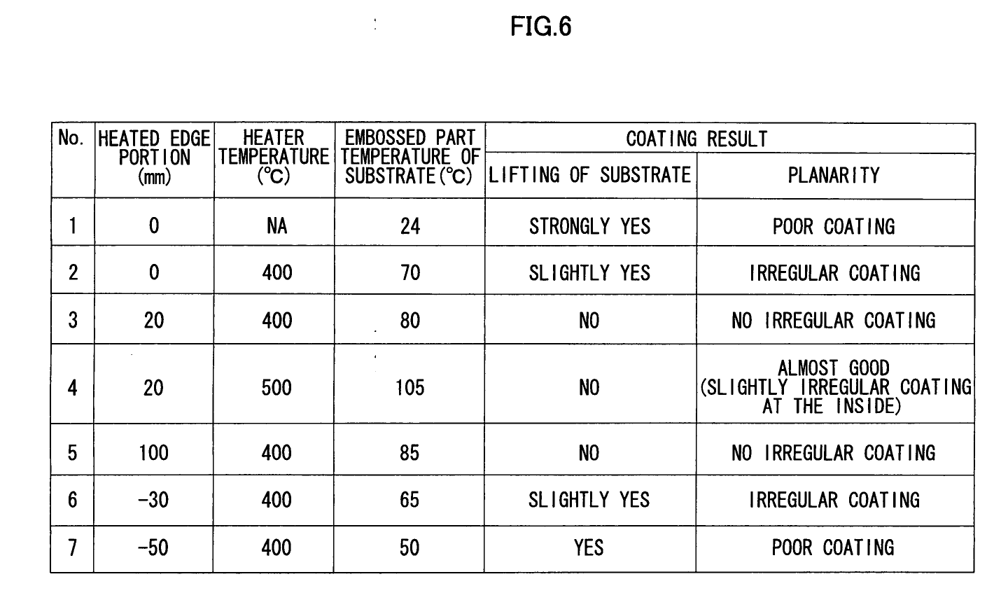

As for respective samples, degree of lifting produced in a coated area of the web 16 and coating performance of the coated film were visually determined by a sensory inspection. Production conditions as described above and evaluation results are summarized in a table shown in FIG. 6.

In No. 1 (Comparative Example) in which heating by an edge heater 15 was not performed, a strong degree of lifting was produced on the web 16 and coating performance was poor. A surface temperature of the embossed part was 24° C.

In No. 2 in which the width W (a heated edge portion) was 0 mm and a preset temperature of the edge heater 15 was 400° C., a surface temperature of the embossed part was 70° C. and a degree of lifting was slightly produced on the web 16, and the coating condition was poor since an irregular coating was created.

In No. 3 in which a width W (an heated edge portion) was 20 mm and a preset temperature of the edge heater 15 was 400° C., a surface temperature of the embossed part was 80° C. and any degree of lifting were not produced on the web 16, and the coating condition was favorable (an irregular coating was not present).

In No. 4 in which a width W (an heated edge portion) was 20 mm and a preset temperature of the edge heater 15 was 500° C., a surface temperature of the embossed part was 105° C. and any degree of lifting were not produced on the web 16, and the coating condition was almost favorable (slightly irregular coating was present at the inside).

In No. 5 in which a width W (an heated edge portion) was 100 mm and a preset temperature of the edge heater 15 was 400° C., a surface temperature of the embossed part was 85° C. and any degree of lifting were not produced on the web 16, and the coating condition was favorable (an irregular coating was not present).

In No. 6 in which a width W (an heated edge portion) was −30 mm and a preset temperature of the edge heater 15 was 400° C., a surface temperature of the embossed part was 65° C. and a degree of lifting was slightly produced on the web 16, and the coating condition was poor since an irregular coating was created.

In No. 7 in which a width W (an heated edge portion) was −50 mm and a preset temperature of the edge heater 15 was 400° C., a surface temperature of the embossed part was 50° C. and a degree of lifting was produced on the web 16, and the coating condition was also poor.

These results show that provision of the edge heater 15 is effective for the present invention. In addition, it has been found that, when a distance between the web 16 and the edge heater 15 is larger since the width W (an heated edge portion) is set at −30 mm or −50 mm, a surface temperature of the embossed part was lower and may result in a poor condition.

### EXAMPLE 2

An optical film (an antiglare film) was produced under the following conditions. A material of the web 16 was the same as in Example 1.

After forming a hard coat layer on the web 16, the resultant web 16 having a length of 2600 m was rolled up, and after 7 days later, a coating solution which was identical to that in Example 1 was applied onto the web 16 under the same condition as in Example 1.

A far-infrared heater (produced by Noritake Co.) was used as an edge heater 15, and this heater was set such that an edge portion of the heater (an inedge) could be located within a range between at a 100 mm distance from an edge of the web 16 toward an inside of the web 16 and at a 30 mm distance from the edge of the web 16 toward an outside of the web 16 (−30 mm) and that the edge portion of the heater could be located at different four points between the above described regions. That is, a width W shown in FIG. 2 was allowed to change from −30 mm to 100 mm.

A surface temperature of the edge heater 15 (a preset temperature) was set at two levels such as 400° C. (Nos. 2, 3, 5, and 6) and 500° C. (Nos. 4 and 7), and for comparison, an edge heater 15 was not used under the condition of No. 1. A surface temperature in the vicinity of the edge (embossed part) of the web 16 was determined by actually measuring thereof with an emission pyrometer at a position immediately after passing the web 16 through the edge heater 15.

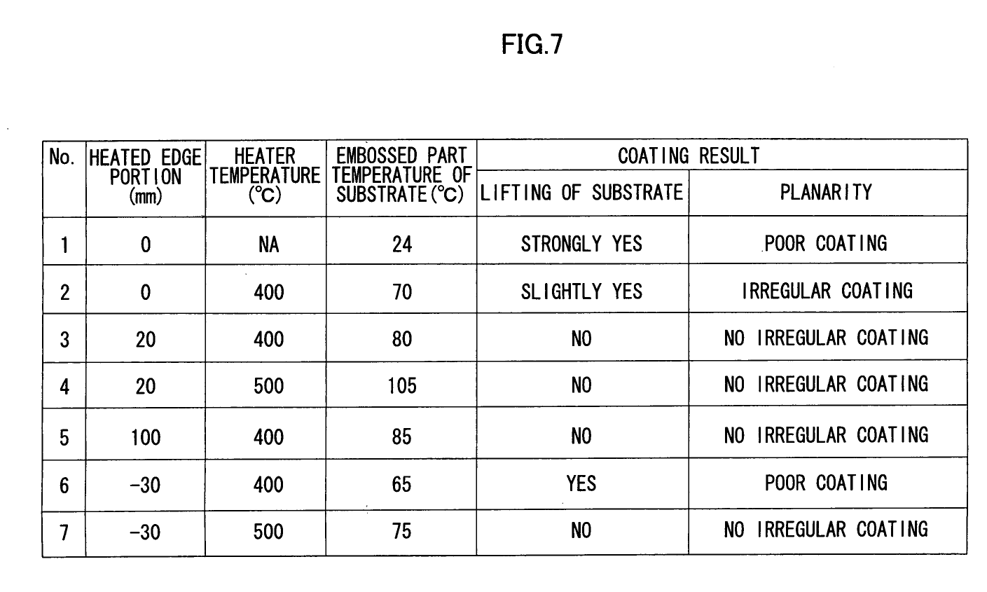

As for respective samples, degree of lifting produced in a coated area of the web 16 and coating performance of the coated film were visually determined by a sensory inspection. Production conditions as described above and evaluation results are summarized in a table shown in FIG. 7.

In No. 1 (Comparative Example) in which heating by an edge heater 15 was not performed, a degree of lifting was strongly produced on the web 16 and coating performance was poor. A surface temperature of the embossed part was 24° C.

In No. 2 in which a width W (an heated edge portion) was 0 mm and a preset temperature of the edge heater 15 was 400° C., a surface temperature of the embossed part was 70° C. and a degree of lifting was slightly produced on the web 16, and the coating condition was poor since an irregular coating was created.

In No. 3 in which a width W (an heated edge portion) was 20 mm and a preset temperature of the edge heater 15 was 400° C., a surface temperature of the embossed part was 80° C. and any degree of lifting were not produced on the web 16, and the coating condition was favorable (an irregular coating was not present).

In No. 4 in which a width W (an heated edge portion) was 20 mm and a preset temperature of the edge heater 15 was 500° C., a surface temperature of the embossed part was 105° C. and any degree of lifting were not produced on the web 16, and the coating condition was favorable (an irregular coating was not present).

In No. 5 in which a width W (an heated edge portion) was 100 mm and a preset temperature of the edge heater 15 was 400° C., a surface temperature of the embossed part was 85° C. and any degree of lifting were not produced on the web 16, and the coating condition was favorable (an irregular coating was not present).

In No. 6 in which a width W (an heated edge portion) was −30 mm and a preset temperature of the edge heater 15 was 400° C., a surface temperature of the embossed part was 65° C. and a degree of lifting was produced on the web 16, and the coating condition was poor since an irregular coating was created.

In No. 7 in which a width W (an heated edge portion) was −30 mm and a preset temperature of the edge heater 15 was 500° C., a surface temperature of the embossed part was 75° C. and any degree of lifting were not produced on the web 16, and the coating condition was favorable (an irregular coating was not present).

These results show that provision of the edge heater 15 is effective for the present invention. In addition, it has been found that, when a distance between the web 16 and the edge heater 15 is larger since the width W (an heated edge portion) is set at −30 mm, an insufficient condition may be produced depending on the heater temperature.

1. A method for conveying a substrate, comprising the step of:
locally heating a region in the vicinity of each edge of a strip-like, flexible substrate which is running by a local heating device, prior to application of a coating solution onto the running substrate by a coating device.

2. The method for conveying a substrate according to claim 1, wherein the substrate is a thermoplastic film, and the local heating device is any of an infrared heater, a far-infrared heater, a visible light lamp, an electrothermal heater, a heating roller, a burner, and a hot air generating device, or a combination thereof.

3. The method for conveying a substrate according to claim 1, wherein the region in the vicinity of the edge along the width direction of the substrate is heated from the front surface and/or back surface of the substrate.

4. The method for conveying a substrate according to claim 2, wherein the region in the vicinity of the edge along the width direction of the substrate is heated from the front surface and/or back surface of the substrate.

5. The method for conveying a substrate according to claim 1, wherein the substrate is heated to the glass transition temperature of the substrate Tg-35° C. or more.

6. The method for conveying a substrate according to claim 4, wherein the substrate is heated to the glass transition temperature of the substrate Tg-35° C. or more.

7. The method for conveying a substrate according to claim 1, wherein the substrate is heated for 0.5 seconds or more.

8. The method for conveying a substrate according to claim 6, wherein the substrate is heated for 0.5 seconds or more.

9. The method for conveying a substrate according to claim 1, wherein the tensile force of the substrate is set at 300 N/m or less.

10. The method for conveying a substrate according to claim 8, wherein the tensile force of the substrate is set at 300 N/m or less.

11. The method for conveying the substrate according to claim 1, wherein the heated region of the substrate which is opposed to the local heating device has a width of 100 mm or less from the edge along the width direction of the substrate.

12. The method for conveying the substrate according to claim 10, wherein the heated region of the substrate which is opposed to the local heating device has a width of 100 mm or less from the edge along the width direction of the substrate.

13. The method for conveying a substrate according to claim 1, wherein the local heating device is divided into several parts along the running direction of the substrate.

14. The method for conveying a substrate according to claim 12, wherein the local heating device is divided into several parts along the running direction of the substrate.

15. The method for conveying a substrate according to claim 1, wherein the local heating device is divided into several parts along the width direction of the substrate.

16. The method for conveying a substrate according to claim 12, wherein the local heating device is divided into several parts along the width direction of the substrate.

17. The method for conveying a substrate according to claim 1, wherein an overall width heating device for heating the overall width of the substrate in the width direction of the substrate is provided upstream and/or downstream of the local heating device along the running direction of the substrate.

18. The method for conveying a substrate according to claim 14, wherein an overall width heating device for heating the overall width of the substrate in the width direction of the substrate is provided upstream and/or downstream of the local heating device along the running direction of the substrate.

19. The method for conveying a substrate according to claim 16, wherein an overall width heating device for heating the overall width of the substrate in the width direction of the substrate is provided upstream and/or downstream of the local heating device along the running direction of the substrate.

20. A coating apparatus, comprising:
a substrate conveying device which conveys a strip-like, flexible substrate,
a coating device which applies a coating solution onto the running substrate; and
a planarity improving device for the substrate which is provided upstream of the coating device in the running direction of the substrate and locally heats a region in the vicinity of each edge of the substrate so as to improve the planarity of the substrate.

21. An optical film, wherein a coating layer is formed on the substrate after employing the method for conveying the substrate according to claim 1.

22. An optical film, wherein a coating layer is formed on the substrate after employing the method for conveying the substrate according to claim 18.

23. An optical film, wherein a coating layer is formed on the substrate after employing the method for conveying the substrate according to claim 19.

24. The optical film according to claim 21, wherein the coating layer has an anti-reflection function.

25. The optical film according to claim 22, wherein the coating layer has an anti-reflection function.

26. The optical film according to claim 23, wherein the coating layer has an anti-reflection function.
